(19) United States
(12) Patent Application Publication
(10) Pub. No.: US 2014/0300469 A1
(43) Pub. Date: Oct. 9, 2014

(54) MULTI-FAULT DETECTING AND ALERTING SYSTEM

(71) Applicant: ASPECT IMAGING LTD., Shoham (IL)

(72) Inventor: Uri RAPOPORT, Moshav Ben Shemen (IL)

(21) Appl. No.: 13/908,174

(22) Filed: Jun. 3, 2013

Related U.S. Application Data
(60) Provisional application No. 61/809,894, filed on Apr. 9, 2013.

(51) Int. Cl. G08B 19/00

(52) U.S. Cl. CPC G08B 19/00
USPC 340/539.22; 340/573.1

(57) ABSTRACT

A multi-fault detecting and alerting system in a medical device. The system includes: a plurality of sensors S; a plurality of indicators I; an alarm connected to at least one of the indicators; and a plurality of wires W. The wires transmit values V sensed by the sensors S to the indicators I. The alarm operates upon receiving, by at least on of the indicators, at least two values V_{ab} and V_{cd} having the relation |V_{ab}-V_{cd}|>X.

### FIELD OF THE INVENTION

The current invention pertains to a multi-fault detecting and alerting system in a medical device for increasing their reliability and the prevention of improper care of patients. The invention also pertains to methods of multi-fault detecting and alerting.

### BACKGROUND OF THE INVENTION

IEC 60601 is a series of technical standards for the safety and effectiveness of medical electrical equipment, published by the International Electro-mechanical Commission. First published in 1977 and regularly updated and restructured. The general standard IEC 60601-1-Medical equipment medical electrical equipment—Part 1: General requirements for basic safety and essential performance—gives general requirements of the series of standards. 60601 is a widely accepted benchmark for medical electrical equipment and compliance with IEC60601-1 has become a de facto requirement for the commercialization of electrical medical equipment in many countries. Many companies view compliance with IEC 60601-1 as a de facto requirement for most markets.

Clause 4.7 of Third Edition IEC 60601-1 addresses the actual issue of electrical safety as it relates to the use of the medical electrical equipment in the process of caring for the patient. The compliance standard requires that the medical system operate safely not only under normal conditions but also in the event of what the IEC calls a “single-fault” condition. Single faults are such occurrences as the failure of a component or the shorting or failure of basic insulation. IEC 60601 requires that in the event of a single-fault, no safety hazard (electrocution, fire, etc.) will occur. These requirements do not pertain to multiple independent faults known as a “double-fault” condition.

Although a single fault system is designed to operate upon failure of one item, it is not designed to operate upon failure of more than one item. The single fault system dramatically decreases the chance of malfunction of medical equipment but a slight chance always remains. This slight chance might be disastrous in the case of medical equipment designed to keep a certain temperature of a neonates incubators, for example. It is well know that a slight deviation from the desirable temperature might be fatal to neonates.

Thus, there is a long felt need for a detecting and alerting system for medical equipment that will further decrease the chances of their malfunction.

### SUMMARY OF THE INVENTION

It is thus an object of the invention to present a multi-fault detecting and alerting system in a medical device. The system comprises, inter alia, a plurality of N sensors Sᵢ; i is an integer between 1 and N indexing each of the N sensors; a plurality of M indicators Iⱼ; j is an integer between 1 and M indexing each of the M indicators; an alarm connected to at least one of Iⱼ; a plurality of M×N wires Wᵢⱼ; the wire Wᵢⱼ connects between (i) the Si; and (ii) the Iⱼ; the Wᵢⱼ transmit value Vᵢⱼ sensed by the Sᵢ to the Iⱼ wherein the alarm operates upon receiving by at least one of the Iⱼ at least two values V_{ab} and V_{cd} having the relation |V_{ab}-V_{cd}|>X; X is a predetermined number.

It is another object of the invention to present the multi-fault detecting and alerting system as defined above, wherein the value is selected from a group consisting of: temperature; heart beat; blood pressure; oxygen saturation; respiration rate; radio frequency signal; humidity; and any combination thereof

It is another object of the invention to present the multi-fault detecting and alerting system as defined above, wherein the sensor is selected from a group consisting of e.g., thermometer; oximeter; blood pressure meter; pulse oximeter; optical breath rate sensor; radio frequency sensor; hygrometer; and any combination thereof

It is another object of the invention to present the multi-fault detecting and alerting system as defined above, wherein the alarm is adapted to operate by producing a signal in a manner selected from a group consisting of e.g., audible signal, visual signal, sensible signal, and any combination thereof.

It is another object of the invention to present the multi-fault detecting and alerting system as defined above, wherein the value Vᵢⱼ is transmitted from the sensor Sᵢ to the Iⱼ wirelessly.

It is another object of the invention to present the multi-fault detecting and alerting system as defined above, wherein it additionally comprising at least one computer readable medium (CRM).

It is another object of the invention to present the multi-fault detecting and alerting system as defined above, wherein at least one CRM is connected to the plurality of

It is another object of the invention to present the multi-fault detecting and alerting system as defined above, wherein at least one CRM has instructions thereon for comparing values transmitted to the plurality of

It is another object of the invention to present the multi-fault detecting and alerting system as defined above, wherein at least one CRM is connected to the alarm.

It is another object of the invention to present the multi-fault detecting and alerting system as defined above, the CRM has additional instructions thereon for activating the alarm when at least two values V_{ab} and V_{cd} have the relation |V_{ab}-V_{cd}|>X; X is a predetermined number.

It is another object of the invention to present the multi-fault detecting and alerting system as defined above, wherein the alarm is connected to the plurality of

It is another object of the invention to present the multi-fault detecting and alerting system as defined above, it additionally comprising a plurality of Q alarms; k is an integer between 1 and Q indexing each of the Q alarms.

It is another object of the invention to present the multi-fault detecting and alerting system as defined above, wherein the Q and M are equal.

It is another object of the invention to present the multi-fault detecting and alerting system as defined above, wherein each of the alarms Aₖ is connected to a unique Iⱼ;

It is another object of the invention to present the multi-fault detecting and alerting system as defined above, wherein V_{ab} and V_{cd}, a≠c and b=d.

It is another object of the invention to present the multi-fault detecting and alerting system as defined above, wherein the plurality of Q alarms are adapted to operate upon receiving by the unique Iⱼ at least two values V_{ab} and V_{cd} having the relation |V_{ab}-V_{cd}|>X; X is a predetermined number.

It is another object of the invention to present the multi-fault detecting and alerting system as defined above, is additionally comprising a plurality of C computer readable mediums (CRMₙ); n is an integer between 1 and C indexing each of C alarms.

It is another object of the invention to present the multi-fault detecting and alerting system as defined above, wherein Q, C and M are equal.

It is another object of the invention to present the multi-fault detecting and alerting system as defined above, wherein each of the plurality of CRMₙ is connected to a unique

It is another object of the invention to present the multi-fault detecting and alerting system as defined above, wherein each of the CRMₙ is connected to a unique alarm Aₖ.

It is another object of the invention to present the multi-fault detecting and alerting system as defined above, wherein the CRMₙ has instructions thereon for comparing values transmitted to the unique Iⱼ.

It is another object of the invention to present the multi-fault detecting and alerting system as defined above, wherein the CRMₙ has additional instructions thereon for activating the unique alarm Aₖ when at least two values V_{ab} and V_{cd} have the relation |V_{ab}-V_{cd}|>X; X is a predetermined number.

It is another object of the invention to present the multi-fault detecting and alerting system as defined above, wherein V_{ab} and V_{cd}, a≠c and b=d.

It is another object of the invention to present a method of multi-fault detecting and alerting in a medical device, comprising steps of: providing: a plurality of N sensors Sᵢ; i is an integer between 1 and N indexing each of the N sensors; a plurality of M indicators Iⱼ; j is an integer between 1 and M indexing each of the M indicators; an alarm; a plurality of M×N wires Wᵢⱼ; the wire Wᵢⱼ connects between (i) Si; and (ii) Iᵢ; connecting the alarm to at least one of Iᵢ; connecting between Si; and Iⱼ; by wires Wᵢⱼ; sensing values by Sᵢ; transmitting the values by Wᵢⱼ to Iⱼ; wherein the alarm is operating upon receiving by at least one of Iⱼ at least two values V_{ab} and V_{cd} having the relation |V_{ab}-V_{cd}|>X; X is a predetermined number.

It is another object of the invention to present the multi-fault detecting and alerting method as defined above, wherein the method additionally comprising a step of selecting the value from a group consisting of e.g., temperature; heart beat; blood pressure; oxygen saturation; respiration rate; radio frequency signal; humidity; and any combination thereof

It is another object of the invention to present the multi-fault detecting and alerting method as defined above, wherein the method additionally comprising a step of selecting the sensor from a group comprising any suitable diagnosing means and analytical apparatus, such as thermometers; oximeters; barometers and blood pressure meters; pulse oximeters; optical breath rate sensors; radio frequency sensors; hygrometers; clocks and time indicators, location indicators such as GPS and related systems, accelerators and velocity meters, tension meters, pH meters, conductivity meters, AKG devices, rehometers, viscosimeters, analyte measurement equipments, microbial detecting kits, detectors and systems thereof for determining biochemistry of animal fluids, such as blood biochemistry, detectors utilizable in microbiology and analysis thereof, spectrophotometrs, spectroradiometers, etc., and any combination thereof

It is another object of the invention to present the multi-fault detecting and alerting method as defined above, wherein the alarm is operating by producing a signal in a manner selected from a group consisting of e.g., audible signal, visual signal, sensible signal, and any combination thereof

It is another object of the invention to present the multi-fault detecting and alerting method as defined above, the step of transmitting the value Vᵢⱼ is travelling from the sensor Sᵢ to the Iⱼ wirelessly.

It is another object of the invention to present the multi-fault detecting and alerting method as defined above, wherein the method additionally comprising a step of providing at least one computer readable medium (CRM).

It is another object of the invention to present the multi-fault detecting and alerting method as defined above, wherein the method additionally comprising a step of connecting at least one CRM to the plurality of Iⱼ.

It is another object of the invention to present the multi-fault detecting and alerting method as defined above, wherein the method additionally comprising a step of giving at least one CRM instructions thereon for comparing values transmitted to the plurality of Iⱼ.

It is another object of the invention to present the multi-fault detecting and alerting method as defined above, wherein the method additionally comprising a step of connecting at least one CRM to the alarm.

It is another object of the invention to present the multi-fault detecting and alerting method as defined above, wherein the method additionally comprising a step of providing a plurality of Q alarms Aₖ; k is integer between 1 and Q indexing each od said Q alarms.

It is another object of the invention to present the multi-fault detecting and alerting method as defined above, wherein Q and M are equal.

It is another object of the invention to present the multi-fault detecting and alerting method as defined above, wherein the method additionally comprising a step of connecting alarms Aₖ to a unique

It is another object of the invention to present the multi-fault detecting and alerting method as defined above, wherein the method additionally comprising a step of the plurality of Q alarms operating upon receiving from the unique at least two values V_{ab} and V_{cd} having the relation |V_{ab}-V_{cd}|>X; X is a predetermined number.

It is another object of the invention to present the multi-fault detecting and alerting method as defined above, wherein the method additionally comprising a step of giving at least one CRM additional instructions thereon for activating the alarm when at least two values V_{ab} and V_{cd} have the relation |V_{ab}-V_{cd}|>X; X is a predetermined number.

It is another object of the invention to present the multi-fault detecting and alerting method as defined above, wherein the method additionally comprising a step of providing a plurality of C computer readable mediums (CRMₙ); n is an integer between 1 and C indexing each of C alarms.

It is another object of the invention to present the multi-fault detecting and alerting method as defined above, wherein Q, C and M are equal.

It is another object of the invention to present the multi-fault detecting and alerting method as defined above, wherein the method additionally comprising a step of connecting the plurality of CRMₙ to a unique Iⱼ;

It is another object of the invention to present the multi-fault detecting and alerting method as defined above, wherein the method additionally comprising a step of connecting the plurality of CRMₙ to a unique Aₖ.

It is another object of the invention to present the multi-fault detecting and alerting method as defined above, wherein the method additionally comprising a step of giving the CRMₙ instructions thereon for comparing values transmitted to the unique Iⱼ.

It is another object of the invention to present the multi-fault detecting and alerting method as defined above, wherein the method additionally comprising a step of giving the CRMₙ additional instructions thereon for activating the unique alarm Aₖ when at least two values V_{ab} and V_{cd} have the relation |V_{ab}-V_{cd}|>X; X is a predetermined number.

It is another object of the invention to present the multi-fault detecting and alerting method as defined above, wherein V_{ab} and V_{cd}, a≠c and b=d.

It is still another object of the invention to present a medical device, comprising or being in either direct or remote connection with a multi-fault detecting and alerting system as defined in any of the above.

It is still another object of the invention to present an MRD comprising or being in either a direct or a remote connection with a multi-fault detecting and alerting system as defined in any of the above.

It is still another object of the invention to present a medical device, especially yet not exclusively an MRD, operable by a multi-fault detecting and alerting method as defined in any of the above.

It is still another object of the invention to present animal's or neonate's incubator comprising or being in either direct or remote connection with a multi-fault detecting and alerting system as defined in any of the above.

An animal's or neonate's incubator operatable by a multi-fault detecting and alerting method as defined in any of the above.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 is a schematic illustration of a double-fault detecting and alerting system in a thermometer (100);

FIG. 2 is a schematic illustration of a triple-fault detecting and alerting system in a thermometer (200); and

FIG. 3 is a schematic flow diagram describing a method for using a multi-fault detecting and alerting system (300).

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figure and described in the specification, but only as indicated in the accompanying claims, with the proper scope determined only by the broadest interpretation of said claims.

The term “sensor” refers hereinafter to a converter that measures a physical quantity and converts it into a signal which can be read by an observer or by an (today mostly electronic) instrument.

The term “value” refers hereinafter to a numerical quantity measured by a sensor. More specifically the term relates to temperature, number of heart beats per minute, pressure, percentage of oxygen in blood, number of breaths per minute, radio frequency, water saturation in air, etc.

The term “Magnetic Resonance Device (MRD)” specifically applies hereinafter to any Magnetic Resonance Imaging (MRI) device, any Nuclear Magnetic Resonance (NMR) spectroscope, any Electron Spin Resonance (ESR) spectroscope, any Nuclear Quadruple Resonance (NQR) spectroscope or any combination thereof. The MRD hereby disclosed is optionally a portable MRI device, such as the commercially available portable devices by ASPECT Magnet Technologies Ltd, or a commercially available non-portable device. Moreover, the term ‘MRD’ generally refers in this patent to any medical device, at least temporary accommodating an anesthetized animal.

As used herein, the term “animal” or “mouse” generally refers in an interchangeable manner to any living creature, such as neonates, other mammal such as mice, rats, cats, dogs, rabbits etc and laboratory animals.

As used herein, the term “neonate” generally refers to any object or living creature, such as human being or other mammal and preferably refers to babies.

As used herein, the term “incubator” may include isolate-like devices each of which is a self-contained incubator unit that provides a controlled heat, humidity, and oxygen microenvironment for the isolation and care of premature and low-birth weight neonates. The apparatus is often made of a clear plastic material and has a large door and portholes for easy access to the infant with a minimum of heat and oxygen loss. A servo control mechanism constantly monitors the infant's temperature and controls the heat within the unit. The term “incubator” also refers to an apparatus in which environmental conditions, such as temperature, concentration of gases and humidity, can be controlled in a scandalized manner, such as the IEC 60601 standard and IEC 6061-2-19, IEC 201.12.102, IEC 201.12.1.104, IEC 201.12.1.108, IEC 12 201.12.1.107, IEC 201.12.103 standards which are all incorporated herein in as a reference.

A triple-fault system and a double-fault system are simplified examples of a multi-fault system. The method for a multi-fault system includes a plurality of N sensors Si; i is an integer between 1 and N indexing each of said N sensors; a plurality of M indicators Iⱼ; j is an integer between 1 and M indexing each of said M indicators; an alarm; and a plurality of M×N wires Wᵢⱼ; said wire Wᵢⱼ connects between (i) said Si; and (ii) said Iⱼ; connecting said alarm to at least one of said Iⱼ; connecting between said Si; and said Iⱼ; by said wires Wᵢⱼ; sensing values by said Sᵢ transmitting said values by said Wᵢⱼ to said The alarm is operating upon receiving by said at least one of said Iⱼ at least two values V_{ab} and V_{cd} having the relation |V_{ab}-V_{cd}|>X; X is a predetermined number.

### EXAMPLE 1

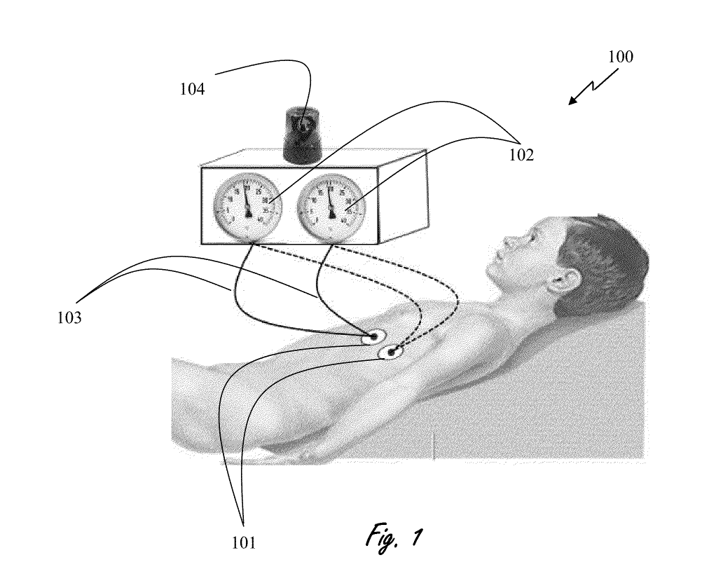

Reference is now made to FIG. 1, illustrating a schematic view of a medical device adapted to measure the temperature of a patient, such a neonate in his life supporting incubator.

An example of a double-fault detecting and alerting system in a thermometer. This thermometer is comprised of two sensors (Sᵢ=S₁,S₂) (101) adapted to sense body temperature and two indicators (Iⱼ=I₁,I₂) (102). Each sensor is connected to each indicator by wires (Wᵢⱼ=W₁₁,W₁₂,W₂₁,W₂₂) (103). Four temperature values are received by this system (Vᵢⱼ=V₁₁,V₁₂,V₂₁,V₂₂), as a result of the four combinations possible between sensors and indicators. The system additionally comprises an alarm (104) adapted to alert when the difference in the temperature value received by different combinations of sensor and indicator is larger than X. X is a certain predetermined number: for example 1 Celsius degree.

According to the current example the alert is in a form of light which turns on. The fact that the light turned on does not mean that the temperature is dangerous for the patient but it rather indicate on some fault in the system. The fault can be that the sensor isn't attached properly to the patient or that a wire got disconnected.

If one of the temperature values show a temperature which demands attention to the patient and the other values are normal, the first thing to be done is taking care of the patient and only then the source of the difference should be revealed.

### EXAMPLE 2

Various international standards define parameter safety parameters form a premature neonates in their incubator. Hence for example, IEC 6061-2-19 Standard Clauses 12 201.12.101 (Stability of incubator); IEC 201.12.102 (Uniformity of incubator temperature); IEC 201.12.103 (Accuracy of skin temperature sensor); IEC 201.12.1.104 (accuracy between skin temperature and control temperature during removal, transportation and insertion within said MRD device); IEC 201.12.1.108 (overshoot time) and/or IEC 12 201.12.1.107 (warm up time) each or those standards is incorporated herein as a reference. In case of IEC 201.12.103, accuracy of skin temperature sensor, the multi-fault system is designed to alert when there is no compatibility between the different temperatures detected, e.g., +/−0.5 degrees Celsius.

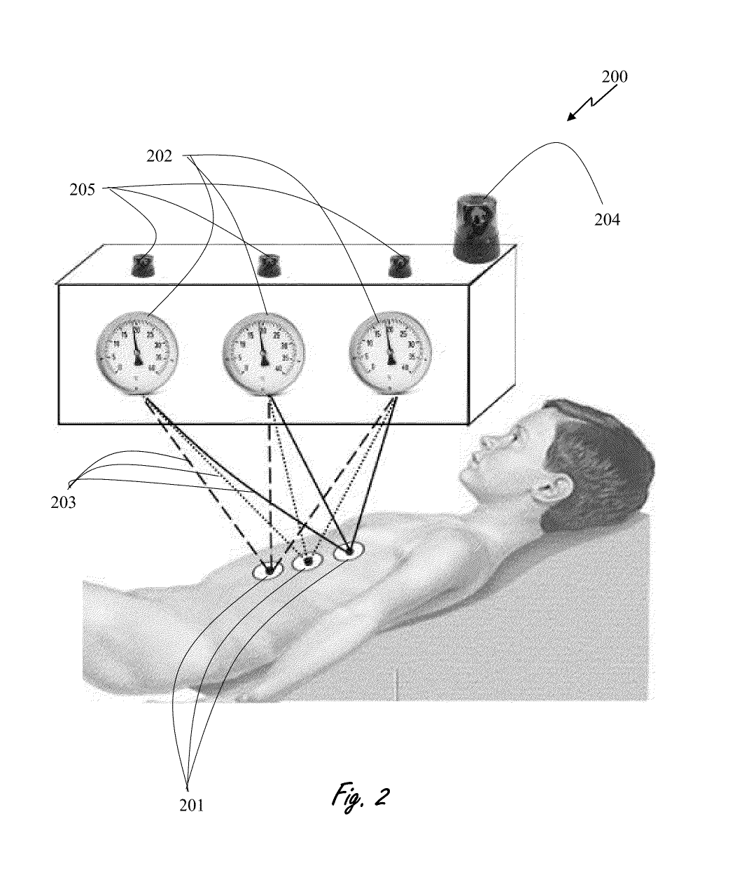

An example of a triple-fault detecting and alerting system in a thermometer: reference is now made to FIG. 2, illustrating a schematic view of a medical device adapted to measure the temperature of a patient, such a neonate in his life supporting incubator.

The neonate or an animal in his incubator is connected thus to three temperature sensors (thermometers Sᵢ=S₁,S₂,S₃) (201). Each sensor is connected to all indicators, (thermo-indicators, means of indications, Iⱼ=I₁,I₂,I₃) (202) by wires (Wᵢⱼ=W₁₁,W₁₂,W₁₃,W₂₁, W₂₂,W₂₃,W₃₁,W₃₂,W₃₃) (103) which transmit the temperature values (Vᵢⱼ=V₁₁,V₁₂,V₁₃,V₂₁,V₂₂, V₂₃,V₃₁,V₃₂,V₃₃) measured by the sensors. Each indicator is connected to an alarm (e.g., an alerting system adapted to flash red lights and emit sound whilst remote indicating the fault to a medical personnel located in another room, Aᵢ=A₁,A₂,A₃) (105) is adapted to alert when the temperatures between the sensors connected to each indicator are inconsistent (for example, V₁₁≠V₂₁, here in case of +/−0.5 degrees Celsius). Additionally all the indicators are connected to an alarm (204) adapted to alert on any inconsistency between the values received by the different indicators (for example, V₁₁≠V₁₂).

Reference is now made to FIG. 2, illustrating by means of the said medical device in connection with the said triple-fault detecting and alerting system, a method for using a multi-fault detecting and alerting system in a medical device.

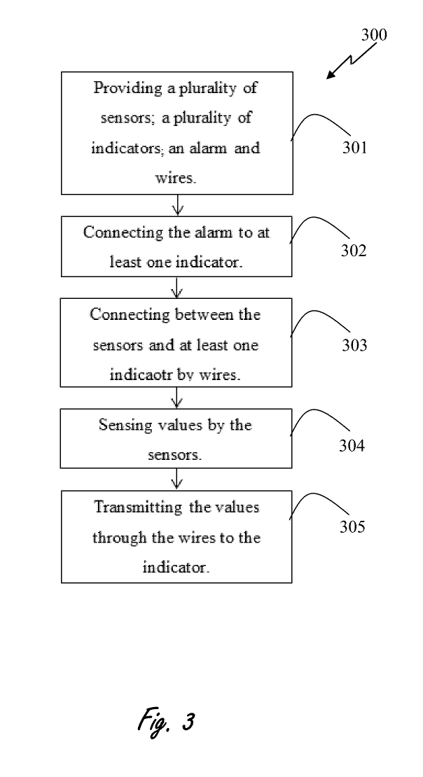

Reference is now made to FIG. 3. In the first step (301) sensors, indicators, an alarm and wires are provided. In the first example (double-fault) two sensors, two indicators, four wires and an alarm is provided. In the second example, three sensors, three indicators, 9 wires and an alarm is provided (additional 3 alarms are later added). These are examples in which there are equal amounts of sensors and indicators. Other situations in which there are different numbers of sensors and indicators are also possible. The number of the wires will always be the multiplication of the number of sensors with the number of indicators if each indicator is connected to each sensor.

The next step in the method is connecting the alarm to at least one indicator (302). If the alarm is connected to only one indicator than it can alert only on differences in values transmitted to this indicator by different sensors. If the alarm is connected to all the indicators (as exemplified in examples 1-2) than it can alert upon any difference in values.

In the third step the sensors are connected to the indicators (303) so values measured by them can be transmitted to the indicators (304).

According to an embodiment of the invention, the multi-fault detecting and alerting system describe above is provided useful the said environmental sensing and alarm system is selected from the group consisting of a temperature alarm humidity alarm, air supply alarm, oxygen concentration alarm, CO₂ concentration alarm.

According to an embodiment of the invention, the multi-fault detecting and alerting system describe above is provided useful wherein it is adapted to maintain temperature conditions substantially similar to said host infant incubator temperature conditions wherein said capsule has a steady temperature condition within a range of about +/−0.5 degrees Celsius of said incubator when said capsule is transported from said incubator to said MRD device.

According to an embodiment of the invention, the multi-fault detecting and alerting system describe above is provided useful wherein said predetermined steady temperature condition is maintained over a period of at least one hour when checked at about 32 degrees Celsius and about 36 degrees Celsius.

According to an embodiment of the invention, the multi-fault detecting and alerting system describe above is provided useful wherein said multi-fault detecting and alerting system is adapted to maintain similar temperature conditions to said baby controlled incubator namely said predetermined steady temperature condition during baby control mode are maintained such that the skin temperature of the neonate does not differ from said predetermined steady temperature condition by more than 0.7 degrees Celsius.

According to an embodiment of the invention, the multi-fault detecting and alerting system describe above is provided useful wherein it is adapted to maintain similar conditions to said incubator namely that when the control temperature of said incubator is set at 12 degrees Celsius above ambient temperature, supply voltage being equal to the rated voltage, said incubator operating as an air controlled infant incubator, said infant incubator is switched on starting from cold condition, and time for the incubator temperature to rise by 11 degrees Celsius is measured, the warm up time of said capsule substantially conforms with warm up time of said incubator.

According to an embodiment of the invention, the multi-fault detecting and alerting system describe above is provided useful wherein said capsule is adapted to maintain an overshoot temperature of 2 degrees Celsius temperature within said incubator.

According to an embodiment of the invention, the multi-fault detecting and alerting system describe above is provided useful wherein said capsule is adapted to maintain said temperature during a 15 minute steady state temperature condition restoration period.

According to yet another embodiment of the invention, the multi-fault detecting and alerting system described above is provided useful to maintain substantially similar temperature conditions to that of said incubator when said infant incubator is operated as an air controlled incubator at a control temperature of 32 degrees until said steady state temperature is reached, and the temperature is then adjusted to a control temperature of 36 degrees Celsius, the overshoot of incubator and the time to reach the new steady temperature condition from the first passage of 36 degrees Celsius being measured.

1. A multi-fault detecting and alerting system in a medical device, comprising:
a. a plurality of N sensors Sᵢ; i is an integer between 1 and N indexing each of said N sensors;
b. a plurality of M indicator Iⱼ; j is an integer between 1 and M indexing each of said M indicators;
c. an alarm connected to at least one of said Iⱼ; and,
d. a plurality of M×N wires Wᵢⱼ; said wire Wᵢⱼ connects between (i) said S ; and (ii) said Iⱼ; said Wᵢⱼ transmit value Vᵢⱼ sensed by said Sᵢ to said Iⱼ wherein said alarm operates upon receiving by said at least on of said Iⱼ at least two values V_{ab} and V_{cd} having the relation |V_{ab}-V_{cd}|>X; X is a predetermined number.

2. The system of claim 1, wherein at least one of the following is being held true (a) said value is selected from a group consisting of temperature; heart beat; blood pressure; oxygen saturation; respiration rate; radio frequency signal; humidity, and any combination thereof; (b) said sensor is selected from a group consisting of thermometer; oximeter; blood pressure meter; pulse oximeter; optical breath rate sensor; radio frequency sensor; hygrometer, and any combination thereof; (c) alarm is adapted to operate by producing a signal in a manner selected from a group consisting of audible signal, visual signal, sensible signal, and any combination thereof; (d) said value Vᵢⱼ is transmitted from said sensor Sᵢ to said Iⱼ wirelessly; and any combination thereof

3. The system of claim 1, additionally comprising at least one computer readable medium (CRM).

4. The system of claim 3, wherein said at least one CRM is connected to said plurality of Iⱼ.

5. The system of claim 4, wherein said at least one CRM has instructions thereon for comparing values transmitted to said plurality of Iⱼ.

6. The system of claim 5, wherein said at least one CRM is connected to said alarm.

7. The system of claim 6, wherein said CRM has additional instructions thereon for activating said alarm when said at least two values V_{ab} and V_{cd} have the relation |V_{ab}-V_{cd}|>X; X is a predetermined number.

8. The system of claim 1, wherein said alarm is connected to said plurality of

9. The system of claim 8 additionally comprising a plurality of Q alarms Aₖ; k is an integer between 1 and Q indexing each of said Q alarms.

10. The system of claim 9, wherein said Q and said M are equal.

11. The system of claim 10, wherein said each of said alarms Aₖ is connected to a unique

12. The system of claim 11, wherein said V_{ab} and said V_{cd}, a≠c and b=d.

13. The system of claim 12, wherein said plurality of Q alarms are adapted to operate upon receiving by said unique Iⱼ at least two values V_{ab} and V_{cd} having the relation |V_{ab}-V_{cd}|>X; X is a predetermined number.

14. The system of claim 8, additionally comprising a plurality of C computer readable mediums (CRMₙ); n is an integer between 1 and C indexing each of said C alarms.

15. The system of claim 14, wherein said Q, said C and said M are equal.

16. The system of claim 15, wherein each of said plurality of CRMₙ is connected to a unique Iⱼ.

17. The system of claim 16, wherein said each of said CRMₙ is connected to a unique alarm Aₖ.

18. The system of claim 17, wherein said CRMₙ has instructions thereon for comparing values transmitted to said unique Iⱼ.

19. The system of claim 18, wherein said CRMₙ has additional instructions thereon for activating said unique alarm Aₖ when said at least two values V_{ab} and V_{cd} have the relation |V_{ab}-V_{cd}|>X; X is a predetermined number.

20. The system of claim 19, wherein said V_{ab} and said V_{cd}, a≠c and b=d.

21. A method for using a multi-fault detecting and alerting system in a medical device, comprising steps of:
a. providing the following:
i. a plurality of N sensors Sᵢ; i is an integer between 1 and N indexing each of said N sensors;
ii. a plurality of M indicators Iⱼ; j is an integer between 1 and M indexing each of said M indicators;
iii. an alarm; and
iv. a plurality of M×N wires Wᵢⱼ; said wire connects between (i) said Si; and (ii) said
b. connecting said alarm to at least one of said Iⱼ;
c. connecting between said Si; and said Iⱼ; by said wires Wᵢⱼ;
d. sensing values by said Sᵢ; and
e. transmitting said values by said Wᵢⱼ to said Iⱼ.
wherein said alarm is operating upon receiving by said at least one of said at least two values V_{ab} and V_{cd} having the relation |V_{ab}-V_{cd}|>X; X is a predetermined number.

22. The method of claim 21, additionally comprising at least one step selected from a group consisting of (a) selecting said value from a group consisting of: temperature, heartbeat, blood pressure, oxygen saturation, respiration rate; radio frequency signal, humidity, and any combination thereof; (b) selecting said sensor from a group consisting of thermometer, oximeter, blood pressure meter, pulse oximeter, optical breath rate sensor, radio frequency sensor, hygrometer, and any combination thereof; (c) said alarm is operating by producing a signal in a manner selected from a group consisting of audible signal, visual signal, sensible signal, and any combination thereof; (d) transmitting said value Vᵢⱼ is travelling from said sensor Sᵢ to said Iⱼ wirelessly; (e) providing at least one computer readable medium (CRM); and any combination thereof

23. The method of claim 22, additionally comprising a step of connecting said at least one CRM to said plurality of

24. The method of claim 23, additionally comprising a step of giving said at least one CRM instructions thereon for comparing values transmitted to said plurality of

25. The method of claim 24, additionally comprising a step of connecting said at least one CRM to said alarm.

26. The method of claim 25, additionally comprising a step of giving said at least one CRM additional instructions thereon for activating said alarm when said at least two values V_{ab} and V_{cd} having the relation |V_{ab}-V_{cd}|>X; X is a predetermined number.

27. The method of claim 21, additionally comprising a step of connecting said alarm to said plurality of Iⱼ.

28. The method of claim 27, additionally comprising a step of providing a plurality of Q alarms Aₖ; k is integer between 1 and Q indexing each od said Q alarms.

29. The method of claim 28, wherein said Q and said M are equal.

30. The method of claim 29, additionally comprising a step of connecting said alarms Aₖ to a unique Iⱼ.

31. The method of claim 30, additionally comprising a step of said plurality of Q alarms operating upon receiving from said unique Iⱼ at least two values V_{ab} and V_{cd} having the relation |V_{ab}-V_{cd}|>X; X is a predetermined number.

32. The method of claim 31, wherein said V_{ab} and said V_{cd}, a≠c and b=d.

33. The method of claim 32, additionally comprising a step of providing a plurality of C computer readable mediums (CRMₙ); n is an integer between 1 and C indexing each of said C alarms.

34. The method of claim 33, wherein said Q, said C and said M are equal.

35. The method of claim 34, additionally comprising a step of connecting said plurality of CRMₙ to a unique Iⱼ.

36. The method of claim 35, additionally comprising a step of connecting said plurality of CRMₙ to said a unique Aₖ.

37. The method of claim 36, additionally comprising a step of giving said CRMₙ instructions thereon for comparing values transmitted to said unique Iⱼ.

38. The method of claim 37, additionally comprising a step of giving said CRMₙ additional instructions thereon for activating said unique alarm Aₖ when said at least two values V_{ab} and V_{cd} have the relation |V_{ab}-V_{cd}|>X; X is a predetermined number.

39. The method of claim 38, wherein said V_{ab} and said V_{cd}, a≠c and b=d.

40. A medical device, comprising or being in either a direct or a remote connection with a multi-fault detecting and alerting system as defined in claim 1.

41. An MRD according to claim 40, comprising or being in either a direct or a remote connection with a multi-fault detecting and alerting system.

42. An animal's or neonate's incubator comprising or being in either a direct or a remote connection with a multi-fault detecting and alerting system as defined in claim 1.

43. A medical device, operable by a multi-fault detecting and alerting method as defined in claim 21.

44. An MRD operable by a multi-fault detecting and alerting method as defined in claim 21.

45. An animal's or neonate's incubator operable by a multi-fault detecting and alerting method as defined in claim 21.
